(19) United States
(12) Patent Application Publication
(10) Pub. No.: US 2025/0259228 A1
(43) Pub. Date: Aug. 14, 2025

(54) DYNAMIC WHOLE-STORE PATH GENERATION WITH LOCATION PRIORITIZATION FOR RETAIL STORE LOCATIONS

(71) Applicant: Target Brands, Inc., Minneapolis, MN (US)

(72) Inventors: Brandon Reuter, Minneapolis, MN (US); Gagan Mahajan, Plymouth, MN (US); Eric Runquist, Hopkins, MN (US); Vidya Attivilli, Mooresville, NC (US)

(21) Appl. No.: 18/441,332

(22) Filed: Feb. 14, 2024

(51) Int. Cl. G06Q 30/0601; G06Q 10/047; G06Q 10/087

(52) U.S. Cl. CPC G06Q 30/0639; G06Q 10/047; G06Q 10/087

(57) ABSTRACT

In some implementations, a method performed by data processing apparatuses includes receiving a request from a client device indicative of multiple items and a current location of the client device, identifying one or more locations within the retail store corresponding to each item based on inventory data, selecting a best location of the one or more locations for each item based on a priority associated with each location of the one or more locations, determining a route that starts at the current location of the client device and includes the best location for each respective item of the plurality of items, and transmitting the route to the client device.

### TECHNICAL FIELD

This specification generally relates to techniques for location services, particularly techniques for generating paths to items in a retail store.

### BACKGROUND

Retail stores are increasingly using automated systems for retail store logistics management. For example, certain systems may process online orders from a retail store by generating a pick list identifying products or other items to be collected from shelves located in the retail store sales floor. An employee may collect items from the pick list and deliver those items to a customer, checkout location, or other destination location. Typical systems may identify item locations based on location labels, such as shelf numbers. Typical systems may identify multiple locations within the retail store that may contain a particular item.

### SUMMARY

This document generally describes computer systems, processes, program products, and devices for generating paths to items within a retail store, for example to pick those items to fulfill an order. Items may be located in multiple locations throughout the retail store, including locations on the sales floor and locations in stockrooms or other back room areas. Each of those areas may be relatively more or less difficult to access, and may include varying levels of inventory. Further, inventory levels may vary dynamically over time. Accordingly, generating efficient routes to access multiple items within the retail store may be difficult, particularly when considering accessibility of each item and/or dynamic inventory levels. The technology described in this document involves a map system that receives a request for a route to multiple items within the retail store. The map system determines a preferred location for each item in the list based on current inventory and, if the item is available in multiple locations, relative priority of those locations. The map system generates an optimal or otherwise efficient route from the current location of the client device to the location determined for each item. The map system may dynamically re-generate the path based on updated information from the client device such as updated availability information for one or more items.

In some implementations, a method performed by data processing apparatuses includes receiving a request from a client device, the request indicative of a plurality of items and a current location of the client device; identifying, for each respective item of the plurality of items, one or more locations within the retail store corresponding to the respective item based on inventory data, wherein each of the one or more locations comprises a physical location within the retail store; selecting, for each respective item of the plurality of items, a best location of the one or more locations corresponding to the respective item based on a priority associated with each location of the one or more locations; determining a route that starts at the current location of the client device and includes the best location for each respective item of the plurality of items; and transmitting the route to the client device.

Other implementations of this aspect include corresponding computer systems, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. Selecting the best location based on the priority may include determining whether each location is located within a back room of the retail store or a sales floor of the retail store. Selecting the best location based on priority may further include determining relative accessibility of each location. The current location of the client device may be determined with a local positioning system of the retail store. The method may further include receiving an update from the client device in response to transmitting the route, the update indicative of a first item of the plurality of items being unavailable at a first location and an updated location of the client device; identifying, for the first item, one or more remaining locations within the retail store corresponding to the first item in response to receiving the update, wherein the one or more remaining locations do not include the first location; selecting a best location of the one or more remaining locations based on the priority associated with each location of the one or more remaining locations; determining an updated route that starts at the updated location of the client device and includes the best location of the one or more remaining locations; and transmitting the updated route to the client device. The method may further include determining whether the updated location of the client device is within a predetermined distance of the first location; wherein transmitting the updated route comprises transmitting the updated route in response to determining that the updated location is within the predetermined distance. The method may further include determining, for the first item, that no remaining locations within the retail store correspond to the first item in response to receiving the update; and requesting an inventory audit in response to determining that no remaining locations correspond to the first item. Determining the route that includes the best location for each respective item of the plurality of items may include, for each pair of the best locations, determining an actionable path between the pair of the best locations using a pathfinding algorithm; and determining an approximately shortest route by inputting all of the actionable paths between the pairs of the best locations to a heuristic algorithm. Determining the actionable path between the pair of best locations using the pathfinding algorithm may include determining the actionable path between the pair of best locations using an A* pathfinding algorithm; and determining the approximately shortest route by inputting all of the actionable paths to the heuristic algorithm may include inputting all of the actionable paths to a traveling salesman problem algorithm. The method may further include representing the retail store as a matrix of accessible areas and obstacles based on predetermined map data associated with the retail store; and generating a graph representing the retail store based on the matrix, wherein each vertex of the graph represents an obstacle corner and each edge represents an immediate connection between a pair of obstacle corners; wherein determining the actionable path between the pair of the best locations using the pathfinding algorithm comprises determining the actionable path based on the graph. Generating the graph representing the retail store may include assigning to each edge of the graph a weight indicative of a walkable distance between the pair of obstacle corners. Generating the graph representing the retail store may include assigning to each edge of the graph a weight indicative of an estimated walking time between the pair of obstacle corners, wherein edges within a back room area of the retail store have a slower estimated walking rate than edges within a sales floor area of the retail store. Generating the graph representing the retail store may include assigning to each edge of the graph a weight indicative of an estimated time based on average walking speed associated with an area associated with the edge of the graph.

The systems, devices, program products, and processes described throughout this document can, in some instances, provide one or more of the following advantages. In particular, the techniques described herein may provide improved picking efficiency compared to current technologies. In particular, the technologies described herein may generate improved paths based on physical location data of the user and a single selected location for each item. The generated routes may improve retail efficiency by prioritizing back room locations over sales floor locations, thereby increasing available inventory on the sales floor. Further, the technologies described herein may dynamically adjust routes based on retail store inventory reported by the user. Accordingly, the technologies herein may provide efficient and accurate item picking for order fulfillment.

Other features, aspects and potential advantages will be apparent from the accompanying description and figures.

### DESCRIPTION OF DRAWINGS

FIG. 1 depicts an example system for dynamically generating paths to items in a retail store.

FIG. 2 is a flow diagram of an example technique for generating a route for multiple items in a retail store and providing that route to a client device.

FIG. 3 is a flow diagram of an example technique for dynamically repathing a request for a route based on an update received from the client device.

FIG. 4 is a flow diagram of an example technique for determining a best path for multiple items in a route request.

FIG. 5 is a schematic diagram that shows an example of a route that may be generated for multiple items in a retail store.

FIG. 6 is a schematic diagram that shows an example of a dynamically repathed route generated in response to an update received from the client device.

FIG. 7 is a schematic diagram that shows an example of a computing device and a mobile computing device.

Like reference symbols in the various drawings indicate like elements.

### DETAILED DESCRIPTION

This document describes technology for automatically generating a route to reach multiple items in a retail store, for example to pick those items to fulfill an order. Briefly, a map system receives a request from a client device (e.g., a smartphone, tablet computer, or other mobile computing device) that identifies multiple items, as well as a physical location of the client device. The map system identifies all locations within the store for those items, including locations within the sales floor and any back rooms, storerooms, or locations other than the sales floor. The map system prioritizes among those locations and selects only the highest-priority location for each item. After determining the highest-priority locations, the system determines a best route that includes all of the items, starting at the current location of the client device and ending at a defined end location. In response to updates received from the client device, the map system may dynamically repath and regenerate an updated route based on the current location of the client device and updated inventory information.

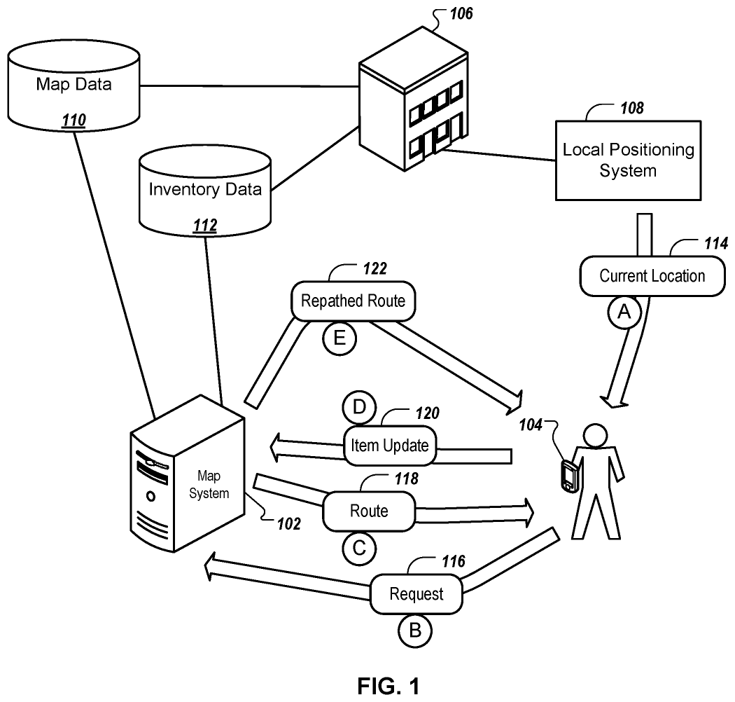

FIG. 1 depicts an example system 100 for automatically generating routes for multiple items in a retail store, as represented in example stages (A) to (E). Stages (A) to (E) may occur in the illustrated sequence, or they may occur in a sequence that is different than in the illustrated sequence, and/or two or more stages (A) to (E) may be concurrent. In some examples, one or more stages (A) to (E) may be repeated multiple times when dynamically repathing and/or regenerating routes.

The system 100 can include a map system 102 and one or more client devices 104. The system 102, for example, can include one or more computing servers and one or more data sources. In some examples, multiple of the system 102 can be combined into a single system, and/or any of the systems can be partitioned into two or more separate systems. In some examples, the computing servers can include various forms of servers, including but not limited to network servers, web servers, application servers, or other suitable computing servers. In some examples, the data sources can include databases, file systems, and/or cached data sources. The computing servers, for example, can access data from the data sources, can execute software that processes the accessed data, and can provide information based on the accessed/processed data to client devices that can be operated by users. Communication between the computing servers, the data sources, and the client devices, for example, can occur over one or more communication networks, including a LAN (local area network), a WAN (wide area network), and/or the Internet.

In the present example, a user, such as an employee, team member, or other worker, can employ a client device 104 to access the map system 102. The client device 104 may be embodied as any mobile processing device including, but not limited to a laptop computer, a tablet computer, a personal digital assistant (PDA), a smartphone, or another processing device. The client device 104 may access the map system 102 while physically present at a retail store.

As shown, the map system 102 may be located at or otherwise associated with the retail store 106, which includes a local positioning system 108. The local positioning system 108 may be embodied as any device or collection of devices that allows client devices 104 to determine their current physical location within a particular facility or other location. For example, the local positioning system 108 may include a system of beacons installed in an indoor location (e.g., personal area network beacons or other radio beacons, visible light beacons installed in light fixtures and/or other location beacons).

During stage (A), a current location 114 of the client device 104 is

determined. Illustratively, the client device 104 determines its current location 114 within the retail store 106 using the local positioning system 108. Additionally or alternatively, the client device 104 may use any appropriate technique to determine its physical location within the retail store 106. For example, the client device 104 may use a global positioning system (GPS) receiver, capable of determining the precise coordinates of the client device 104. As another example, the client device 104 may triangulate or trilaterate the position of the client device 104 using distances or angles to wireless access points, cellular network towers, or other radio beacons with known positions and/or may determine the approximate position of the client device 104 based on association to wireless networks with known positions.

During stage (B), the client device 104 sends a request 116 for a route to the map system 102. The request 116 identifies a list of particular items and provides the current location 114 of the client device 104. The provided list of items may correspond to a customer order or other collection of items to be picked from the retail store 106. The map server 102 uses map data 110 and inventory data 112 related to the retail store 106 to determine a best location within the retail store 106 for each requested item, and to generate a route 118 that starts from the current location 114 and reaches the best location for each item. During stage (C), this route 118 is provide to the client device 104, which may display the route 118, for example using a mapping application. The user of the client device 104 may proceed to use the route 118 to pick the items from their respective locations within the retail store 106.

During stage (D), the client device 104 may send an item update 120 to the map system 102. The item update 120 indicates that a particular item is not located at the location included in the route 118. For example, the user of the client device 104 may reach the location indicated in the route 118, determine that the item is not available, and then cause the client device 104 to send the item update 120 to the map system 102. The item update 120 also includes or is otherwise indicative of the current location 114 of the client device 104, which may be determined as described above. In response to the item update 120, the map system 102 performs a repathing operation, in which a best remaining location within the retail store 106 is determined for each remaining requested item, considering the item update 120. The map system 102 sends a repathed route 122 to the client device 104 that includes the updated route. The user of the client device 104 may continue picking items starting from the current location of the client device 104 using the repathed route 122.

Accordingly, the system 100 may generate optimal or otherwise improved routes for picking items in the retail store 106. The generated routes are determined holistically based on the entire retail store 106 rather than based on individual segments, and may include locations within the sales floor and back room areas. Further, the system 100 may use inventory levels, accessibility, efficiency of picking, and other factors to prioritize locations for items. Additionally, the system 100 provides for dynamic repathing including dynamically regenerating routes based on inventory updates.

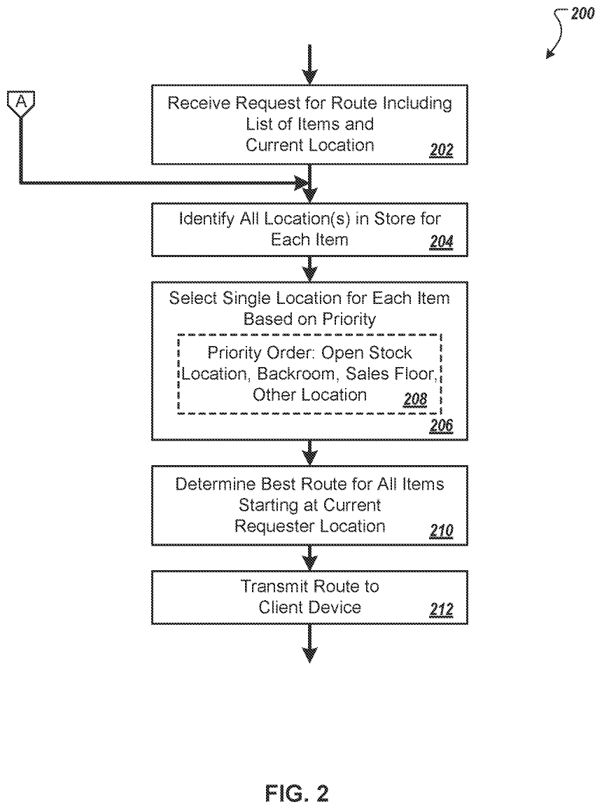

Referring now to FIG. 2, a flow diagram of an example method 200 is shown for generating a route for multiple items in a retail store and providing that route to a client device 104. In the present example, the method 200 can be performed by components of the system 100 such as the map system 102, and will be described with reference to FIG. 1. However, other systems may be used to perform the same or a similar process.

At 202, the map system 102 receives a request 116 for a route from a client device 104 (e.g., a smartphone, laptop computer, tablet computer, or other device used by an employee or over user). The request 116 includes or otherwise identifies a list of items and a current location 114 of the client device 104. Each item may describe a particular product, stock keeping unit (SKU), or other item that is located within the retail store 106. The list of requested items may be associated with a particular customer's shopping order or similar list of items. Accordingly, in some embodiments the request 116 may include or otherwise be associated with an order identifier or other indication of the list of items. Additionally or alternatively, rather than being associated with a customer order, in some embodiments the request 116 may indicate one or more items for sales floor replenishment. As described above, the current location 114 of the client device 104 may include physical coordinates or other information indicative of the physical location of the client device 104 within the retail store 106. The client device 104 may determine the current location 114, for example, using the local positioning system 108, a global positioning system, or other location techniques as described above.

At 204, the map system 102 identifies all locations within the retail store 106 for each requested item described by the request 116. Inventory for a particular item may be located in multiple different locations within a retail store, including locations within a sales floor area (e.g., shelves, end caps, or other display areas) and/or within a stock room or other back room area (e.g., shelves, pallets, or other locations). The map system 102 may, for example, query inventory data 112 for the retail store 106 to determine all locations within the retail store 106 that have items for a particular requested product. The inventory data 112 may include real-time inventory data, regularly updated inventory data, and/or other data indicative of the current number and/or location of particular items within the retail store 106. The inventory data 112 may be updated, for example, in response to worker scans of items located throughout the retail store 106.

At 206, the map system 102 selects a single location for each requested item based on a priority order. The priority order may be determined based on efficiency of access, inventory efficiency, or other factors. Accordingly, when a particular product is available in multiple locations, the map system 102 may select the best location-that is, the location having the highest relative priority among available locations. In some embodiments, at 208 the map system 102 may prioritize open stock locations as the highest priority, followed by backroom locations, sales floor locations, and other locations in that order. Open stock locations may include open shelves, opened pallets, opened totes, or other locations within a stock room or other back room location in which the item is readily accessible. Other, lower-priority backroom locations may include unopened bulk packages, unopened pallets, or other locations in which the item is less accessible. Those locations may require additional time for the employee to access, for example by requiring a bulk package to be opened. Sales floor locations may include locations in shelves, end caps, bins, or other locations accessible to customers of the retail store 106. Other locations may include additional locations in which the items are relatively less accessible to employees, such as high locations that may require a ladder, fork truck, or other equipment to access, bulk locations, or other relatively less accessible locations.

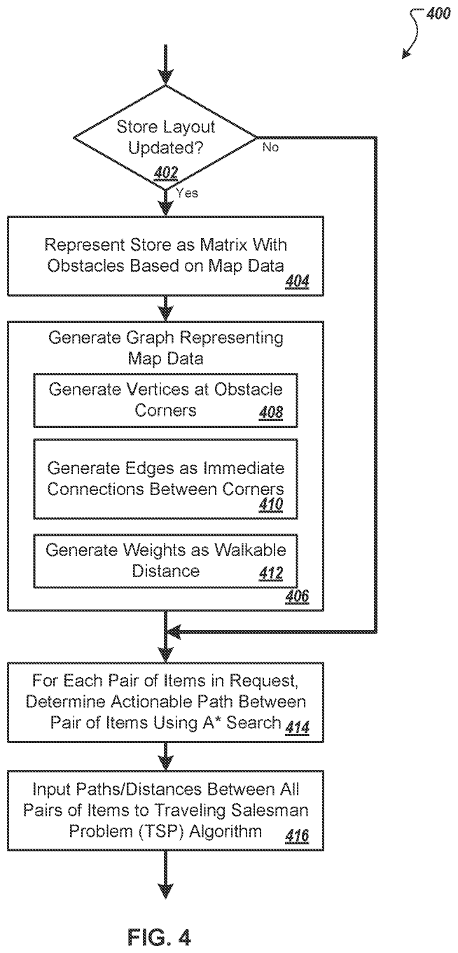

At 210, the map device 102 determines a best route 118 that includes all of the locations determined for the requested items, starting at the current location 114 of the client device 104, and ending at a specified end location. The map device 102 may determine the best route 118 using map data 110 associated with the retail store 106. The map data 110 may be embodied as planogram data that describes shelves and other fixtures, walls, doorways, and other physical features of the retail store 106. The map device 102 may determine the route 118 using a subgoal graphing algorithm, along with a heuristic algorithm such as a traveling salesman problem (TSP) algorithm. One potential embodiment of a method for determining the best route 118 is described below in connection with FIG. 4.

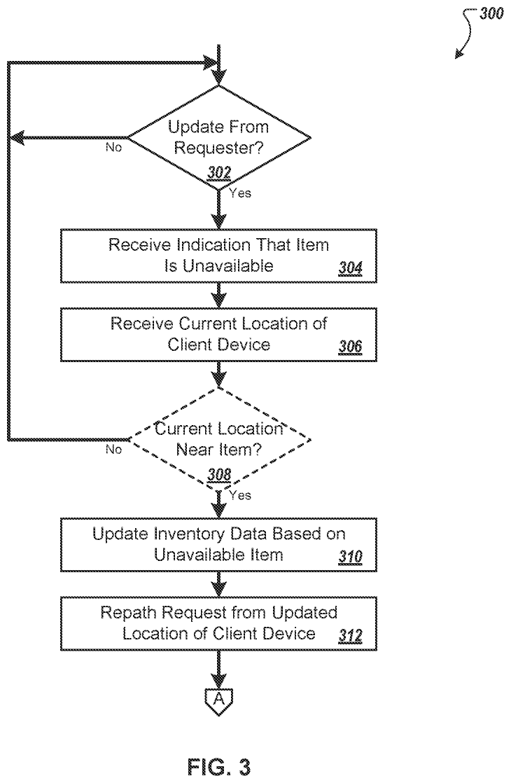

At 212, the map device 102 transmits the determined route 118 to the requesting client device 104. The client device 104 may, for example, display the route 118 to the user, which allows the user to follow the route 118 and pick the requested items. The client device 104 may, for example, display the determined route 118 using a graphical mapping application, as a list of waypoints, or using any other appropriate technique. As described further below in connection with FIG. 3, as the user picks items from the list, the client device 104 may provide updates to the map server 102, for example in response to user input from the user.

Referring now to FIG. 3, a flow diagram of an example method 300 is

shown for dynamically repathing a route based on an update 120 received from the client device 104. In the present example, the method 300 can be performed by components of the system 100 such as the map system 102, and will be described with reference to FIG. 1. However, other systems may be used to perform the same or a similar process.

At 302, the map system 102 determines whether an update 120 has been received from the client device 104. The client device 104 may transmit an update 120, for example, in response to a user input from an employee. The user input may indicate, for example, whether a particular item is actually present at the location specified in the determined route 118. If the map server 102 determines that no update 120 has been received, the method 300 loops back to block 302 in order to continue processing updates. If an update 120 has been received, the method 300 advances to block 304.

At 304, the map system 102 receives an update 120 that includes an indication that a particular item is unavailable at the location described in the route 118. As described above, this indication may be based on user input provided by the employee to the client device 104. At 306, the map system 102 receives the current location 114 of the client device 104. The current location 114 may be determined by the client device 104 as described above, for example using the local positioning system 308. The location 114 may be provided with the update 120 or in a separate message from the client device 104.

At 308, in some embodiments the map system 102 may determine whether the current location 114 is near the location of the item included in the route 118. The map system 102 may, for example, determine whether the current location 114 is within a predetermined threshold distance of the location of the item or otherwise determine proximity of the current location 114 relative to the location of the item. If the current location 114 is not near the location of the item, the method 300 loops back to block 302 to continue processing additional updates from the client device 104. Accordingly, the method 300 may require that the client device 104 (and thus the user of the client device 104) be physically nearby the location of the item before reporting that the item is unavailable. This may improve inventory accuracy, prevent workers from avoiding certain locations, and otherwise improve picking efficiency. Referring again to block 308, if the current location 114 is near the location of the item, the method 300 advances to block 310.

At 310, the map system 102 updates inventory data based on the unavailable item. The map system 102 may, for example, update the inventory data 112 to reflect the lack of inventory at the location determined in the route 118. Additionally or alternatively, the map system 102 may record that the item is not available at the location without updating the inventory data 112. In those embodiments, the map system 102 may record the item as not available until the inventory data 112 is updated (e.g., overnight or in response to an inventory audit), until a certain amount of time passes (e.g., one day or more), or otherwise temporarily record the item as unavailable. In some embodiments, one or more inventory systems or other systems may request or otherwise initiate an inventory audit. For example, in an embodiment, an inventory audit may be requested or otherwise initiated if the user indicates that the item is not found at any location within the retail store 106.

At 312, the map system 102 repaths the request from the updated current location 114 of the client device 104. The map system 102 may, for example, generate an updated route 122 including the best path to locations for all remaining items in an order. For the item that was reported as not available, the map system 102 may use the remaining location for that item having the highest priority, determined as described above in connection with FIG. 2. For example, if the user via the client device 104 reports that an item is not available in a back room location, the map server 102 may determine the updated best route 122 including a location within the sales floor associated with that item. By dynamically repathing the request 116 based on the updated location of the client device 104, the map system 102 may generate the best route 122 based on updated conditions. After repathing, the method 300 branches back to block 204, shown in FIG. 2 and described above, to generate the best route 122 and transmit the updated best route 122 to the client device 104.

Referring now to FIG. 4, a flow diagram of an example method 400 is shown for generating a route 118 for multiple items in a retail store 106. In the present example, the method 400 can be performed by components of the system 100 such as the map system 102, and will be described with reference to FIG. 1. However, other systems may be used to perform the same or a similar process.

At 402, the map system 102 determines whether a store layout of the retail store 106 has been updated. The map system 102 may, for example, determine whether the map data 110 has changed or otherwise determine whether the store layout has changed. If the store layout has not changed, the method 400 branches ahead to block 414, described below. If the store layout has changed (and/or during the initial run of the method 400), the method 400 advances to block 404.

At 404, the map system 102 represents the retail store 106 as a matrix with obstacles based on the map data 110. As described above, the map data 110 may describe the retail store 106 including walls, doorways, shelves and other fixtures, and other items within the retail store 106. The map data 110 may include or be based on planogram data, computer-aided drafting (CAD) files, vector files, or other representations of the store 106. The matrix representation may be embodied as rectangular grid of cells, with each cell representing a physical location within the retail store 106. The value of each cell (e.g., a Boolean value) indicates whether the cell is part of an obstacle (e.g., part of a wall, shelf or other fixture, or otherwise inaccessible to a person) or whether the cell is walkable (e.g., a hallway, doorway, or other walkable space).

At 406, the map system 102 generates graph data representing the map data 110, using the matrix representation of the retail store 106. As described above, the graph data may only be generated when the layout of the retail store 106 changes, and thus may be re-used between multiple runs of the method 400. At 408, the map system 102 generates vertices within the graph based on the matrix representation. Each vertex represents a corner of an obstacle in the matrix representation. At 410, the map system 102 generates edges within the graph as immediate connections between corners of obstacles within the matrix representation. At 412, the map system 102 generates weights for each edge in the graph. In the illustrative embodiment, each weight represents walkable distance between the vertices associated with the edge (i.e., walkable distance of the immediate connection between corners of obstacles). Additionally or alternatively, in some embodiments the weights may represent another metric, such as estimated walking time between obstacle corners. Continuing that example, edges located in sales floor areas may have a faster estimated walking rate (and therefore a shorter estimated walking time) as compared to edges located in back room areas due to, for example, larger aisle width in the sales floor area. As another example, the weights may represent estimated walking time based on average walking speed associated with an area associated with the edge. Continuing that example, the average walking speed may be determined based on current or predicted guest traffic, seasonal data, predicted team member collisions, or other factors.

After the graph representing the map data is generated, at 414 the map system 102 determines an actionable path between each pair of items in the request using an A* pathfinding search algorithm. The A* algorithm is a graph traversal and path search algorithm that identifies a path between two nodes in a graph having the smallest cost. In the illustrative embodiment, the A* algorithm finds the path between each pair of items in the graph having the shortest walkable distance. Although illustrated as using the A* algorithm, it should be understood that in other embodiments, the map system 102 may use any appropriate pathfinding algorithm.

At 416, the map system 102 inputs the paths with associated distances between all pairs of items to a traveling salesman problem (TSP) algorithm. The TSP algorithm performs multiple iterations of a heuristic algorithm that finds an actionable shortest path that reaches all requested items, starting at the current location 114 and ending at the requested ending location. In the illustrative embodiment, the map system 102 may perform a meta-heuristic algorithm based on the JSprit open source library;

however, in other embodiments any appropriate TSP algorithm, vehicle routing problem (VRP) algorithm, or other algorithm may be used. The TSP algorithm provides a result including the route 118 (or updated route 122) between items that is provided to the client device as described above in connection with blocks 210, 212 of FIG. 2. After providing those results, the method 400 is completed. The method 400 may be executed again, for example in connection with a repathing operation as described above in connection with FIG. 3. As described above, the graph data may not be regenerated if the layout of the retail store 106 does not change between runs of the method 400.

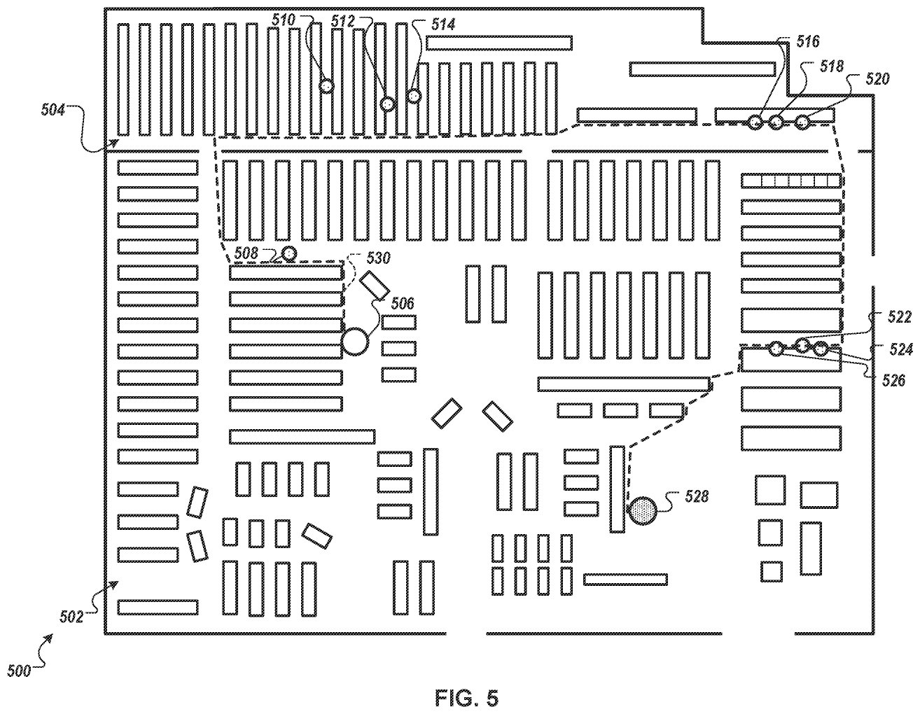

Referring now to FIG. 5, an example retail store 500 is shown. The retail store 500 is represented by map data 110, which is illustrated graphically in FIG. 5. As shown, the retail store 500 includes a sales floor area 502 as well as a backroom area 504. As shown, the aisles within the backroom area 504 are narrower and more closely spaced as compared to the aisles within the sales floor area 502.

In an illustrative example, a client device 104 in use by a user such as a retail store employee may be located at a current location 506. The client device 104 may send a request 116 for a route 118 including multiple items associated with a retail order to the map system 102 as described above. The map system 102 determines a best location for each requested item as described above. Those locations are represented in FIG. 5 as points 508, 510, 512, 514, 516, 518, 520, 522, 524, 526. As shown in FIG. 5, those determined locations are located throughout the retail store 500, including in the sales floor area 502 and the back room area 504. Also shown in FIG. 5 is a destination location 528, which may illustratively be a checkout register or other predetermined order pickup location. As described above, the map system 102 determines a route 530 that starts at the current location 506, reaches each of the items 508, 510, 512, 514, 516, 518, 520, 522, 524, 526, and ends at the destination location 528. As shown, the route 530 follows the immediate connections between corners of obstacles represented in the map data 110 of the retail store 106. For items located on interior shelves such as items 510, 512, 514, the route 530 may include corners of the obstacles representing those shelves. Accordingly, the route 530 is an actionable shortest path, and is illustratively optimized according to smallest walkable distance.

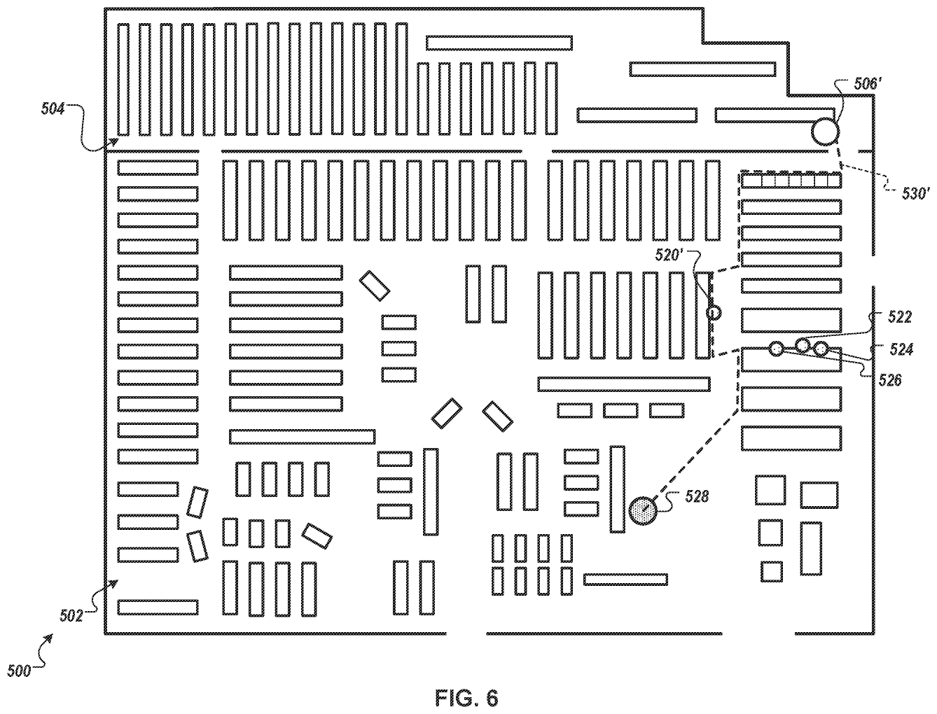

The client device 104 may display a representation of the route 530, for example using a mapping application or other user interface. The user of the client device 104 may use the route 130 to pick items for the order from their respective locations within the retail store. Referring now to FIG. 6, the client device 104 may provide an update 120 to the map system 102. In the illustrative example, the client device 104 may send the update from an updated current location 506′. Continuing the illustrative example, the update indicates that the item associated with the original best location 520 was not available at that location. In response to the update, the map system 102 performs a repathing operation as described above in connection with FIG. 3. In particular, the map system 102 identifies a new location 520′ for the item that was not present at the original location 520. In the illustrative embodiment, the new location 520′ is located within the sales floor area 502, and thus may have a lower priority as compared to the original location 520 shown in FIG. 5, which is located within the back room area 504. During the repathing operation, the map system 102 generates an updated route 530′ that includes the new location 520′ and the remaining locations 522, 524, 526 from the original route 530. The map system 102 may identify which items to include in the updated route 530′ using any appropriate technique; for example, the map system 102 may automatically record the location 114 of the client device 104 as it passes items in the route 530, the map system 102 may include items that were sequentially after the missing item in the original route 530, or the map system 102 may receive user input indicating which items have been successfully picked. Similar to the original route 530, the client device 104 may display a representation of the updated route 530′ as described above, and the user of the client device 104 may continue to pick items using the updated route 530′.

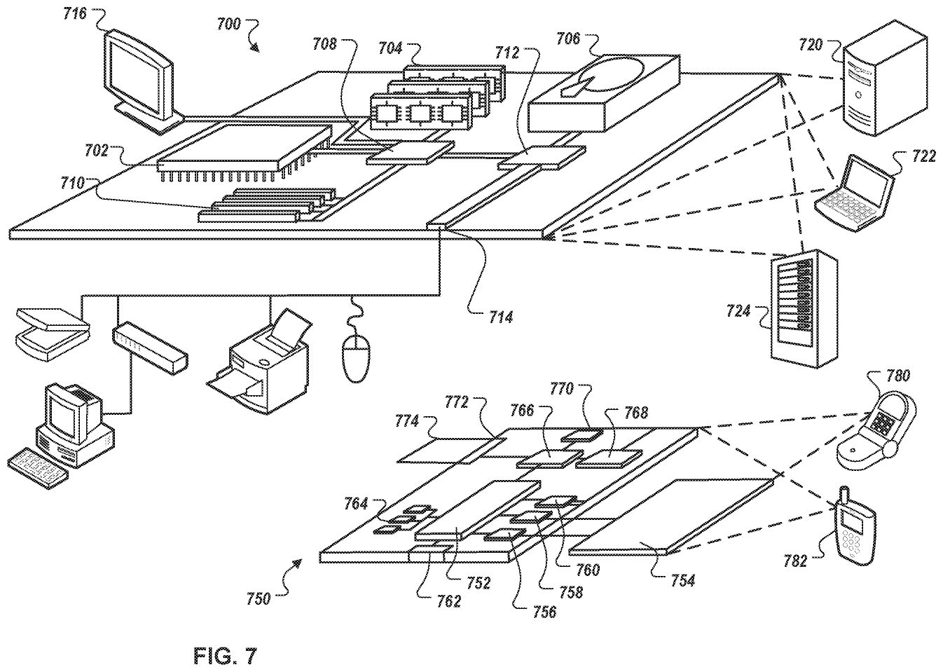

FIG. 7 shows an example of a computing device 700 and an example of a mobile computing device 750 that can be used to implement the techniques described here. The computing device 700 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and can be mounted on a common motherboard or in other manners as appropriate. The processor 702 can process instructions for execution within the computing device 700, including instructions stored in the memory 704 or on the storage device 706 to display graphical information for a GUI on an external input/output device, such as a display 716 coupled to the high-speed interface 708. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 can also be another form of computer-readable medium, such as a magnetic or optical disk.

The storage device 706 is capable of providing mass storage for the computing device 700. In some implementations, the storage device 706 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer-or machine-readable medium, such as the memory 704, the storage device 706, or memory on the processor 702.

The high-speed interface 708 manages bandwidth-intensive operations for the computing device 700, while the low-speed interface 712 manages lower bandwidth-intensive operations. Such allocation of functions is exemplary only. In some implementations, the high-speed interface 708 is coupled to the memory 704, the display 716 (e.g., through a graphics processor or accelerator), and to the high-speed expansion ports 710, which can accept various expansion cards (not shown). In the implementation, the low-speed interface 712 is coupled to the storage device 706 and the low-speed expansion port 714. The low-speed expansion port 714, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 700 can be implemented in a number of different forms, as shown in the figure. For example, it can be implemented as a standard server 720, or multiple times in a group of such servers. In addition, it can be implemented in a personal computer such as a laptop computer 722. It can also be implemented as part of a rack server system 724. Alternatively, components from the computing device 700 can be combined with other components in a mobile device (not shown), such as a mobile computing device 750. Each of such devices can contain one or more of the computing device 700 and the mobile computing device 750, and an entire system can be made up of multiple computing devices communicating with each other.

The mobile computing device 750 includes a processor 752, a memory 764, an input/output device such as a display 754, a communication interface 766, and a transceiver 768, among other components. The mobile computing device 750 can also be provided with a storage device, such as a micro-drive or other device, to provide additional storage. Each of the processor 752, the memory 764, the display 754, the communication interface 766, and the transceiver 768, are interconnected using various buses, and several of the components can be mounted on a common motherboard or in other manners as appropriate.

The processor 752 can execute instructions within the mobile computing device 750, including instructions stored in the memory 764. The processor 752 can be implemented as a chipset of chips that include separate and multiple analog and digital processors. The processor 752 can provide, for example, for coordination of the other components of the mobile computing device 750, such as control of user interfaces, applications run by the mobile computing device 750, and wireless communication by the mobile computing device 750.

The processor 752 can communicate with a user through a control interface 758 and a display interface 756 coupled to the display 754. The display 754 can be, for example, a TFT (Thin-Film-Transistor Liquid Crystal Display) display or an OLED (Organic Light Emitting Diode) display, or other appropriate display technology. The display interface 756 can comprise appropriate circuitry for driving the display 754 to present graphical and other information to a user. The control interface 758 can receive commands from a user and convert them for submission to the processor 752. In addition, an external interface 762 can provide communication with the processor 752, so as to enable near area communication of the mobile computing device 750 with other devices. The external interface 762 can provide, for example, for wired communication in some implementations, or for wireless communication in other implementations, and multiple interfaces can also be used.

The memory 764 stores information within the mobile computing device 750. The memory 764 can be implemented as one or more of a computer-readable medium or media, a volatile memory unit or units, or a non-volatile memory unit or units. An expansion memory 774 can also be provided and connected to the mobile computing device 750 through an expansion interface 772, which can include, for example, a SIMM (Single In Line Memory Module) card interface. The expansion memory 774 can provide extra storage space for the mobile computing device 750, or can also store applications or other information for the mobile computing device 750. Specifically, the expansion memory 774 can include instructions to carry out or supplement the processes described above, and can include secure information also. Thus, for example, the expansion memory 774 can be provide as a security module for the mobile computing device 750, and can be programmed with instructions that permit secure use of the mobile computing device 750. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer-or machine-readable medium, such as the memory 764, the expansion memory 774, or memory on the processor 752. In some implementations, the computer program product can be received in a propagated signal, for example, over the transceiver 768 or the external interface 762.

The mobile computing device 750 can communicate wirelessly through the communication interface 766, which can include digital signal processing circuitry where necessary. The communication interface 766 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 768 using a radio-frequency. In addition, short-range communication can occur, such as using a Bluetooth, WiFi, or other such transceiver (not shown). In addition, a GPS (Global Positioning System) receiver module 770 can provide additional navigation-and location-related wireless data to the mobile computing device 750, which can be used as appropriate by applications running on the mobile computing device 750.

The mobile computing device 750 can also communicate audibly using an audio codec 760, which can receive spoken information from a user and convert it to usable digital information. The audio codec 760 can likewise generate audible sound for a user, such as through a speaker, e.g., in a handset of the mobile computing device 750. Such sound can include sound from voice telephone calls, can include recorded sound (e.g., voice messages, music files, etc.) and can also include sound generated by applications operating on the mobile computing device 750.

The mobile computing device 750 can be implemented in a number of different forms, as shown in the figure. For example, it can be implemented as a cellular telephone 780. It can also be implemented as part of a smart-phone 782, personal digital assistant, or other similar mobile device.

Various implementations of the systems and techniques described here can be realized in digital electronic circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computer-implemented method for generating paths to items in a retail store, the method comprising:
receiving a request from a client device, the request indicative of a plurality of items and a current location of the client device;
identifying, for each respective item of the plurality of items, one or more locations within the retail store corresponding to the respective item based on inventory data, wherein each of the one or more locations comprises a physical location within the retail store;
selecting, for each respective item of the plurality of items, a best location of the one or more locations corresponding to the respective item based on a priority associated with each location of the one or more locations;
determining a route that starts at the current location of the client device and includes the best location for each respective item of the plurality of items; and
transmitting the route to the client device.

2. The method of claim 1, wherein selecting the best location based on the priority comprises determining whether each location is located within a back room of the retail store or a sales floor of the retail store.

3. The method of claim 2, wherein selecting the best location based on priority further comprises determining relative accessibility of each location.

4. The method of claim 1, wherein the current location of the client device is determined with a local positioning system of the retail store.

5. The method of claim 1, further comprising:
receiving an update from the client device in response to transmitting the route, the update indicative of a first item of the plurality of items being unavailable at a first location and an updated location of the client device;
identifying, for the first item, one or more remaining locations within the retail store corresponding to the first item in response to receiving the update, wherein the one or more remaining locations do not include the first location;
selecting a best location of the one or more remaining locations based on the priority associated with each location of the one or more remaining locations;
determining an updated route that starts at the updated location of the client device and includes the best location of the one or more remaining locations; and
transmitting the updated route to the client device.

6. The method of claim 5, further comprising:
determining whether the updated location of the client device is within a predetermined distance of the first location;
wherein transmitting the updated route comprises transmitting the updated route in response to determining that the updated location is within the predetermined distance.

7. The method of claim 5, further comprising:
determining, for the first item, that no remaining locations within the retail store correspond to the first item in response to receiving the update; and
requesting an inventory audit in response to determining that no remaining locations correspond to the first item.

8. The method of claim 1, wherein determining the route that includes the best location for each respective item of the plurality of items comprises:
for each pair of the best locations, determining an actionable path between the pair of the best locations using a pathfinding algorithm; and
determining an approximately shortest route by inputting all of the actionable paths between the pairs of the best locations to a heuristic algorithm.

9. The method of claim 8, wherein:
determining the actionable path between the pair of best locations using the pathfinding algorithm comprises determining the actionable path between the pair of best locations using an A* pathfinding algorithm; and
determining the approximately shortest route by inputting all of the actionable paths to the heuristic algorithm comprises inputting all of the actionable paths to a traveling salesman problem algorithm.

10. The method of claim 8, further comprising:
representing the retail store as a matrix of accessible areas and obstacles based on predetermined map data associated with the retail store; and
generating a graph representing the retail store based on the matrix, wherein each vertex of the graph represents an obstacle corner and each edge represents an immediate connection between a pair of obstacle corners;
wherein determining the actionable path between the pair of the best locations using the pathfinding algorithm comprises determining the actionable path based on the graph.

11. The method of claim 10, wherein generating the graph representing the retail store comprises assigning to each edge of the graph a weight indicative of a walkable distance between the pair of obstacle corners.

12. The method of claim 10, wherein generating the graph representing the retail store comprises assigning to each edge of the graph a weight indicative of an estimated walking time between the pair of obstacle corners, wherein edges within a back room area of the retail store have a slower estimated walking rate than edges within a sales floor area of the retail store.

13. The method of claim 10, wherein generating the graph representing the retail store comprises assigning to each edge of the graph a weight indicative of an estimated time based on average walking speed associated with an area associated with the edge of the graph.

14. A computer system comprising:
one or more data processing apparatuses including one or more processors, memory, and storage devices storing instructions that, when executed, cause the one or more processors to perform operations comprising:
receiving a request from a client device, the request indicative of a plurality of items and a current location of the client device;
identifying, for each respective item of the plurality of items, one or more locations within the retail store corresponding to the respective item based on inventory data, wherein each of the one or more locations comprises a physical location within the retail store;
selecting, for each respective item of the plurality of items, a best location of the one or more locations corresponding to the respective item based on a priority associated with each location of the one or more locations;
determining a route that starts at the current location of the client device and includes the best location for each respective item of the plurality of items; and
transmitting the route to the client device.

15. The computer system of claim 14, wherein selecting the best location based on the priority comprises determining whether each location is located within a back room of the retail store or a sales floor of the retail store.

16. The computer system of claim 14, the operations further comprising:
receiving an update from the client device in response to transmitting the route, the update indicative of a first item of the plurality of items being unavailable at a first location and an updated location of the client device;
identifying, for the first item, one or more remaining locations within the retail store corresponding to the first item in response to receiving the update, wherein the one or more remaining locations do not include the first location;
selecting a best location of the one or more remaining locations based on the priority associated with each location of the one or more remaining locations;
determining an updated route that starts at the updated location of the client device and includes the best location of the one or more remaining locations; and
transmitting the updated route to the client device.

17. The computer system of claim 14, wherein determining the route that includes the best location for each respective item of the plurality of items comprises:
for each pair of the best locations, determining an actionable path between the pair of the best locations using a pathfinding algorithm; and
determining an approximately shortest route by inputting all of the actionable paths between the pairs of the best locations to a heuristic algorithm.

18. A non-transitory computer-readable storage medium coupled to one or more processors and having instructions stored thereon which, when executed by the one or more processors, cause the one or more processors to perform operations comprising:
receiving a request from a client device, the request indicative of a plurality of items and a current location of the client device;
identifying, for each respective item of the plurality of items, one or more locations within the retail store corresponding to the respective item based on inventory data, wherein each of the one or more locations comprises a physical location within the retail store;
selecting, for each respective item of the plurality of items, a best location of the one or more locations corresponding to the respective item based on a priority associated with each location of the one or more locations;
determining a route that starts at the current location of the client device and includes the best location for each respective item of the plurality of items; and
transmitting the route to the client device.

19. The non-transitory computer-readable storage medium of claim 18, wherein selecting the best location based on the priority comprises determining whether each location is located within a back room of the retail store or a sales floor of the retail store.

20. The non-transitory computer-readable storage medium of claim 18, the operations further comprising:
receiving an update from the client device in response to transmitting the route, the update indicative of a first item of the plurality of items being unavailable at a first location and an updated location of the client device;
identifying, for the first item, one or more remaining locations within the retail store corresponding to the first item in response to receiving the update, wherein the one or more remaining locations do not include the first location;
selecting a best location of the one or more remaining locations based on the priority associated with each location of the one or more remaining locations;
determining an updated route that starts at the updated location of the client device and includes the best location of the one or more remaining locations; and
transmitting the updated route to the client device.
